(19) United States
(12) Patent Application Publication
(10) Pub. No.: US 2022/0037100 A1
(43) Pub. Date: Feb. 3, 2022

(54) FORCE DETECTING WINDOW LIFT SYSTEM

(71) Applicant: Methode Electronics, Inc., Chicago, IL (US)

(72) Inventor: Eric D. Sherriff, Nelson (CA)

(21) Appl. No.: 17/443,519

(22) Filed: Jul. 27, 2021

Related U.S. Application Data
(60) Provisional application No. 63/057,586, filed on Jul. 28, 2020.

(51) Int. Cl. H01H 13/14; E05F 15/695; B60R 16/00

(52) U.S. Cl. CPC H01H 13/14; E05F 15/695; H01H 2231/026; H01H 2300/01; E05Y 2900/55; B60R 16/005

(57) ABSTRACT

A regulatory-compliant touch force detecting window lift switch for an automobile is described, in which a load cell, such as a strain gauge, a resistance bridge, or an amplifier, is used to detect a driver's or passenger's touch force, and software is used to assess whether to responsively send a control signal to a window lift motor controller to adjust the position of the automobile's windows.

### CROSS-REFERENCE TO RELATED APPLICATIONS

This is a nonprovisional application that is based on and claims the benefit of the filing date and disclosure of U.S. Provisional Patent Application No. 63/057,586, filed Jul. 28, 2020, the content of which is incorporated herein in its entirety.

### BACKGROUND OF THE INVENTION

### Field of the Invention

The present invention relates generally to human-machine interfaces (HMI) in transportation vehicles, specifically finger switches used to control one or more operations of electrical or electro-mechanical systems in vehicles.

### Description of Related Art

Human-machine interfaces (HMI) in transportation vehicles enable operation of vehicle safety, performance, comfort, and other systems. In recent years, touch controls have revolutionized HMIs, often replacing physical buttons, switches, and knobs. Touch controls allow designers the ability to combine or consolidate multiple different interfaces into a single (or at least fewer) interfaces, usually at lower cost. For example, physical audio system switches and inputs (knobs or buttons for volume, station selection, balance, memory, source input selection, etc.) can be replaced with a single touch screen that displays the individual switch's/input's functionality via a graphical user interface (GUI).

Engineers, however, have resisted replacing user-operated powered window lift systems with touch controls, due in part to National Highway Traffic Safety Administration (NHTSA) regulations applicable to finger-engaging, lever-type switches that require the user to pull the lever away from a surface in which the switch mechanism resides.

In fact, mechanical switches are still the dominant window lift control mechanism used in transportation vehicles today.

FIG. 1 is a cross-sectional, side-view, schematic diagram of an NHTSA regulation-compliant, legacy-type, window lift switch apparatus 100 having a flush-mounted switch actuator lever 102 projecting into a finger well 104, a linkage mechanism 106, a hybrid connector (containing both high and low current terminals) 108, a plurality of switch poles and terminals 110, flexible (braided) common wires 112, 114, a plurality of current-carrying wires 116, and a housing 118. The housing 118 may include a light emitting source 120.

In most applications, the switch actuator lever 102 generally has a planar top surface that is flush with a surrounding surface area. It generally has a right-triangle shape when viewed from the side, with a forward-most leading edge that is rounded and smooth for the comfort of the operator. The lever 102 can move up and down following a radius of curvature defined by a center of radius where the lever 102 connects to the housing 118 by a pin (other means for connecting the lever 102 are also possible).

The lever 102 projects into the finger well 104, which is an open space within a vehicle component 122, such as an armrest or center console. The top planar surface of the lever 102 may sit flush with the top surface of the armrest or console.

The linkage mechanism 106 provides an electro-mechanical connection between the lever 102 and the electrical components inside the housing 118, specifically the hybrid connector 108 and the switch poles and terminals 110, which carry the window lift motor current via the flexible (braided) common wires 112, 114 inside the housing 118, and the current-carrying wires 116 extending away from the housing 118.

The light emitting source 120 may be a light emitting diode (LED), such as a red-blue-green (RBG) LED.

FIG. 2 is a schematic wiring diagram 200 for a mid-2010s vehicle window lift switch apparatus 200 having a LIN-based Driver Door Module (DDM) 202 and a discrete DC “logic” based Passenger Door Module (PDM) 204. Also shown are the master window control switches 206, passenger window control switches 208, driver door window regulator motor 210, and passenger door window regulator motor 212. Window lift switches of this type utilize low current that signal the door control modules 202, 204 and DC logic levels when a user engages the actuator lever. The low current switches signal a microcontroller that is built into the switch unit to send a serial data message (over the LIN or a CAN bus) to the dedicated door controller module 202, 204 that powers the respective lift motors 210, 212.

FIG. 3 is a cross-sectional, side-view, schematic diagram for an NHTSA regulation-compliant, low current, window lift switch 300 (a discrete DC logic type and LIN type) that would interoperate with door control modules. Shown are low current connections 302, a printed circuit board (PCB) 304, low current switches 308, switch actuator 310, and actuator linkage mechanism 312. Also shown are four small gauge wires 314 leading away from a housing 316.

In this type of DC logic type switch, four low current connections 302 are provided: “UP” switch, “DOWN” switch, backlighting voltage, and a common ground. The switch 300 closure would ground the UP or DOWN switch line (never at the same time) indicating to the door controller which direction to drive the lift motor (not shown). The backlight voltage level would module the brightness of the light source 304 in the switch (optional).

FIG. 4 is a cross-sectional, side-view, schematic diagram of a mechanical force detecting window lift switch apparatus 400 provided with three connections 422: power, LIN bus, and ground. When the user physically lifts the switch actuator 410, a microcontroller unit (MCU) 420 on a PCB 406 sees the switch closure and sends a LIN message to the door controller to raise the window. Backlighting brightness is governed by another LIN message. Note the same three wires 414, LIN bus 418 and MCU 420 could serve a “gang” of switches such as typically existing in the driver position. It is often that an MCU 420 is less expensive than the individual connector terminals and wires of legacy switches that they replace.

What is needed, however, is an automotive window lift apparatus and controller for power windows that provides a rigid (non-moving) touch input surface that complies with applicable safety regulations, is less expensive than traditional switch mechanisms, can easily replace existing switches without significant modifications to current panel designs, and is visually appealing.

### BRIEF SUMMARY OF THE INVENTION

In one aspect of the invention, a touch force detecting window lift switch apparatus is made for use in an automobile. The switch includes a component that senses and measures a touch force, and is defined by a top surface shaped and made from a material that coordinates with the shape and style of the part of the automobile that the switch is an integral part of Opposite the top surface of the touch force sensing component is a bottom surface. The top and bottom surfaces may be wedge-shaped with a smooth, rounded apex formed by a convergence of the top and the bottom surfaces. The apex is sized to accommodate a user's fingertip curled around it such that the user's finger can reach at least a portion of the bottom surface in order to apply a touch force on the bottom surface using a pulling motion.

In another aspect, a PCB may be positioned between the top and the bottom surfaces of the touch force sensing component. One end of the PCB, opposite the apex, may be substantially rigidly fixed relative within the touch force sensing component. The other end of the PCB, closest to the apex, may be flexibly fixed.

The PCB may include a load cell integrated circuit and a microcontroller. The load cell could be a strain gauge, a resistance bridge, an amplifier, or a similarly suitable device.

In use, an applied touch force on the top or the bottom surface on or near the apex may be detectable by the load cell integrated circuit when the force causes the apex end of the touch force sensing component to flex generally upward or downward, which causes the end of the PCB closest to the apex and its load cell to also move, which is measurable. The load cell integrated circuit may be configured to output an electrical signal indicative of the touch force being applied.

Alternatively, an applied force on the top or the bottom surface on or near the apex may be detectable by touch sensors without any physical flexing or other movement of the touch force detection component. The load cell integrated circuit may be configured to output an electrical signal indicative of this applied touch force.

Whichever configuration is employed, the microcontroller may be configured to receive and process the electrical signals from the load cell.

In another aspect, the window lift switch apparatus components may be embodied in a housing having a finger well cavity into which the apex of the touch force sensing component extends. The opening to the finger well cavity may be defined by the tip of the apex and the edge of the housing opposite the apex, and may have a square, rectangular shape, or other shape or shapes. The housing may also include attachment devices positioned on an outer surface or edge of the housing for securing the housing in an armrest, a door panel, a console, or some other component of the automobile. The housing may also include an end cap for enclosing an opening of the housing. The end cap could include one or more through-hole openings for passing electrical power and signal leads to and from the PCB.

In other aspects, the PCB may include a signal communication component for communicating the electrical signals outputted by the microcontroller to a window lift motor controller. The communication component may be a LIN integrated circuit, a CAN bus, an Ethernet, or other automotive network available in the automobile. The PCB may also include a light source, such as an LED, for backlighting one or more icons or indicia located on the housing.

In another aspect, the PCB may include software or coded instructions stored in a memory device. The software may compute a baseline average signal value from a set of individual touch force signal values outputted by the load cell over a period of time. The individual touch force signal values may be stored in the memory device or in a separate memory device. The software may also compute a short-term average signal value based on some of the individual touch force signal values in the set of touch force signal values stored in memory. The software may further compare a new touch force signal value to the baseline average signal and to the short-term average signal value to determine whether the new touch force signal should be interpreted as an inadvertent touch.

One advantage or benefit of the use of the touch force window switch apparatus described here, as compared to a simple conventional capacitive touch sensor surface, is that it prevents the simultaneous input on the top and bottom that a capacitive sensor would register when a finger curls around the projection as shown (producing conflicting simultaneous up/down detection).

Another advantage or benefit is the realization of an NHTSA/DOT regulatory compliant automotive window lift control without the need for complex mechanical switches and related moving parts such as an actuator/lever, internal linkage, and moving switch contacts, which may fail over repeated use.

Moreover, the present switch eliminates the intrusion of foreign objects, such as dust, sand, food crumbs, and fluids (including rainwater), from the finger well into the switch mechanisms. Thus, durability and useful life are much less of a concern with the present switch compared to legacy/older mechanical window lift switches.

### BRIEF DESCRIPTION OF THE DRAWINGS

FIG. 1 is a cross-sectional, side view, schematic diagram of a regulation-compliant, legacy-type, window lift switch apparatus;

FIG. 2 is a schematic wiring diagram for a mid-2010s vehicle window lift switch apparatus;

FIG. 3 is a cross-sectional, side view, schematic diagram for a regulation-compliant, low-current, window lift switch apparatus;

FIG. 4 is a cross-sectional, side view, schematic diagram of a mechanical force detecting window lift switch apparatus;

FIG. 5 is an isometric, perspective view schematic diagram of a rigid housing for a touch-enabled, force-detecting, window lift switch apparatus according to one embodiment of the invention;

FIG. 6 is a detailed wiring diagram view of a force detecting window lift switch according to another embodiment of the invention;

FIG. 7 is a detailed wiring diagram view of the force detecting window lift switch according to another aspect of the invention;

FIG. 8 is a diagram illustrating how a safety testing procedure may be implemented according to applicable NHTSA/DOT power-operated window regulations (e.g., 49 C.F.R. § 571.118) applied to traditional/legacy window lift switch (left) and a switch according to the present invention (right);

FIG. 9 is an electrical block diagram of a force detecting window lift switch and controller according to another aspect of the present invention; and

FIG. 10 is a schematic diagram showing a user's finger curled around the force detection projection of the force detecting window lift switch according to another embodiment of the present invention.

### DETAILED DESCRIPTION OF THE INVENTION

Several preferred embodiments of the invention are described for illustrative purposes, it being understood that the invention may be embodied in other forms not specifically shown in the drawings. The figures herein are provided for exemplary purposes and are not drawn to scale.

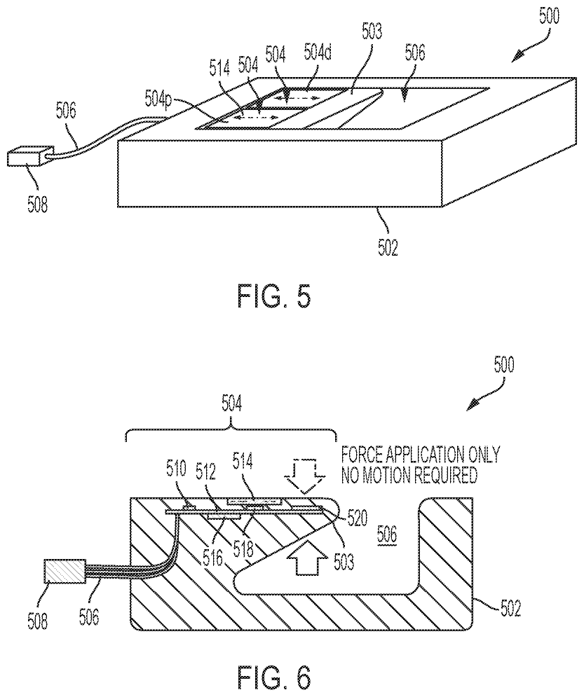

Turning first to FIG. 5, shown therein is an isometric, perspective view schematic diagram of a touch-enabled, force-detecting, window lift switch apparatus 500 according to one aspect of the invention. As shown, the window lift switch apparatus 550 may include a housing 502, a touch force detection projection 503, a touch force-detection projection interface 504, a finger well 506, and an interface indicator/icon 514.

In one aspect, the housing 502 could be integrated into a vehicle interior body structure or components, such as an armrest, door trim panel, or center console, using the same or similar cavity and trim that manufacturers and suppliers already provide for window lift switches. The housing 502 could be injection-molded plastic or cast metal shaped to conform to the interior component in which it is to be integrated, and to provide for rugged, long-lasting use.

The isometric shape of the housing 502 shown is for illustrative convenience. The actual shape of the housing 502, and the components of the window lift switch apparatus 500 may be tailored to take on the organic or angular shapes of specific automotive interior designs. Thus, although the depicted housing 502 is shown as a simple square shape, the housing 502 could be formed into other geometric shapes and have additional or other features, such as other cutouts, depressions, finger wells, etc., including those that are elaborate and ergonomically correct for a window lift HMI.

The force detection projection 503 may have a suitable shape and size to accommodate the user's fingertip as previously described. As shown, the force detection projection 503 extends into and thus defines the shape or contours of the finger well portion 506. As such, the finger well 506 may be a cavity or recessed space for accepting the user's fingertip, much like traditional window lift switches.

The force detection projection 503 is generally a rigid structure, but the portion extending away from the housing 502 and into the finger well 506 could also flex upon the application of a force on either the upper or lower surfaces near tip of the projection 503, depending on the application of the device and the selection of touch sensing components used to sense a touch force applied by the user's finger. Alternatively, the force detection projection 503 is rigid and does not flex upon the application of a force on either the upper or lower surfaces. Instead, the magnitude of the applied force is detected.

The touch force-detection projection indicator 504 is arranged on the top of the housing 502 corresponding to all or a portion of the force detection projection 503 that is viewable by the user. The indicator 504 may include “up” and “down” arrows or other suitable icons or indicia 514 (as best seen in FIG. 6) to indicate direction or purpose to the user. The indicator 504 and its indicia 514 may optionally be backlit as discussed below.

In one aspect, the indicator 504 could include two touch-based, force-detection, window switch actuator indicators 504d (driver side), 504p (passenger side), such as would be provided in a coupe-type (2-door) vehicle having two motorized side windows, one associated with the driver side door and the other associated with the passenger side door. That is, one touch indicator 504d (or one-half portion of a single indicator 504) could enable use of the driver-side window lift, and another touch interface 504p (or the other half portion of the single interface 504) could enable use of the passenger-side window lift.

In sedan- or salon-type vehicles (4-door), four separate touch indicators 504df (driver-side, front), 504dr (driver-side, rear), 504pf (passenger-side, front), 504pr (passenger-side, rear), or four separately designated portions of the single touch interface 504, could be provided, each indicator or portion enabling use of the driver side front and rear window lifts, and the passenger side front and rear window lifts, respectively.

In still another aspect, the electrical components of the window lift switch apparatus 500 could be connected to the vehicle electrical system (and thus to the window lift motors) using a flexible wire pigtail 506 as shown, with or without a molded mating connector 508.

Turning now to FIG. 6, shown therein is a detailed wiring diagram view of the force detecting window lift switch apparatus 500. In one aspect, the window lift switch apparatus 500 may include the force detection projection 503 and finger well 506, and an electronic assembly embodied on a PCB 512, including a load cell 520 integrated circuit, an MCU 516, a LIN 510 integrated circuit, and a light source 518. As described above, a flexible wire pigtail 506 and molded mating connector 508 may be included for connecting the electronics assembly to the vehicle electronics.

The LIN 510 integrated circuit may be used for communications.

The MCU 516 may be used to process signals according to specific logic rules embodied in software algorithms. In one aspect, the MCU 516 may be programmed to account for “aging” and “environmental” drift in force detection signals. It may also be programmed to account for vibration of the various components caused by operation of the automobile over surfaces that causes the automobile body to move on its suspension components. In that regard, the MCU 516 and its software could compute a highly-averaged “baseline” signal F_{T}-ave from a set of touch force signal values {Fₜ₀, Fₜ₁, Fₜ₂, . . . , Fₜₙ} obtained at individual times, t, over a period of time, T. The individual signal values may be stored in memory each time the user touches the interface 504 or at other times. This baseline signal may be used to track aging and environmental effects on the window lift switch apparatus 500.

In another aspect, the MCU 516 may also be programmed to compute a fast-changing minimally-averaged or raw force data signal, Fₜ₋ₐᵥₑ, for comparison with the baseline signal to determine an applied force. For example, the software may be written such that a touch-input signal {Fₜ₀, Fₜ₁, Fₜ₂, . . . , Fₜₙ} is rejected (ignored) unless the signal value Fₜ₋ₐᵥₑ>(f)(F_{T-ave}) (where f is a type of sensitivity parameter, 0<f≤1). That is, the signal value or the minimally-averaged signal value, must be of sufficient magnitude relative to the baseline average to be seen as indicating a user actually intended to engage one or more window lift motors and did not touch the force detection projection 503 inadvertently.

The sensitivity f value may be initially set or reset by a user, depending on their individual preference; or set at a default value by the manufacturer, depending on the type of load cell 520 used, the location of the window lift switch apparatus 500 in the vehicle, or other factor; or it may be learned by a software model trained after a sufficient number of touches have been applied to the window lift switch apparatus 500 by a particular user.

The light source 518 may be one or more LEDs or other suitable light-emitting devices. The light source 518 may be used for backlighting the interface 504 and the control icons or indicia 514 associated with the interface 504.

The load cell 520 integrated circuit may be a strain gauge, a resistance bridge, an amplifier, or some other force-detecting device. For example, in one embodiment, an array of capacitive sensor electrodes (not shown) could be positioned below specific ones of the icons or indicia 514 of the interface 504 and vertically spaced apart from respective fixed metal targets (also not shown) by a gap such that when an applied touch force near one of the capacitive sensor electrodes causes the electrode to move closer to the associated metal target, the load cell 520 integrated circuit outputs a signal at that time, Fₜ, corresponding to the magnitude and location of the touch force.

In one aspect, the force detection projection 503 may include a feedback device (not shown) that provides an audible sound or a haptic sensation (tactile feel) to the user during or after the duration period (i.e., during or after a finger pull or finger push of the switch) and just prior to or simultaneously with the actuation of one or more of the lift motors.

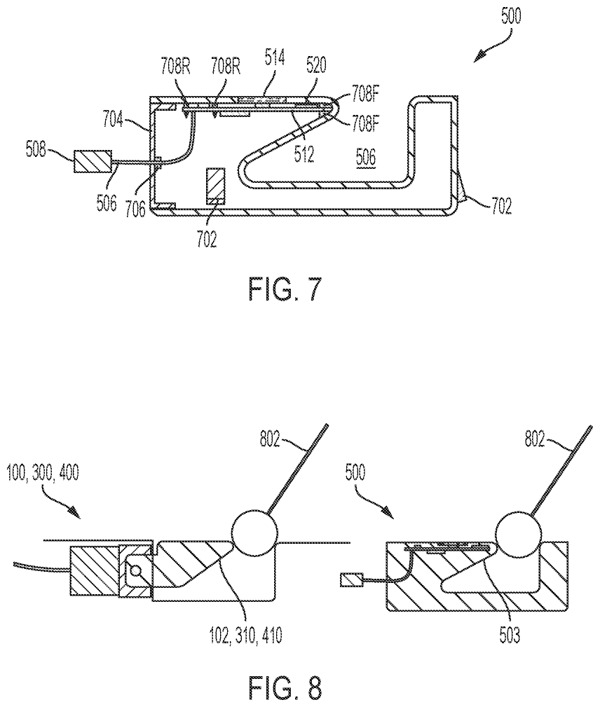

Turning now to FIG. 7, shown therein is a cross sectional side view and detailed wiring diagram view of the force detecting window lift switch apparatus 500.

In one aspect, the housing 502 may include one or more mechanical fastening devices 702 to help secure it in whatever structure it is intended to be placed, such as a cavity in the armrest, the door trim panel, or the center console structure as previously described. The mechanical fastening devices 702 may be one or more snaps, protrusion, or other physical devices space around the bottom, walls, or lip of the housing as needed.

The housing 502 may include a removable end cap 704 having an opening and wire strain relief 706 for the flexible wire pigtail 506.

As shown, a rear portion or end of the PCB 512 away from the load cell integrated circuit 520 may be immobilized using a rear retention mechanism 708R. The rear retention mechanism 708R may consist of, for example, one or more barbed standoffs anchored in the housing 502, snaps, and/or other devices.

The front portion or end of the PCB 512 closest to the load cell integrated circuit 520 may be retained in a front retention mechanism 708F generally at or near the apex of the force detection projection 503. The front retention mechanism 708F may consist of, for example, one or more crush ribs and/or slots molded into the force detection projection 503.

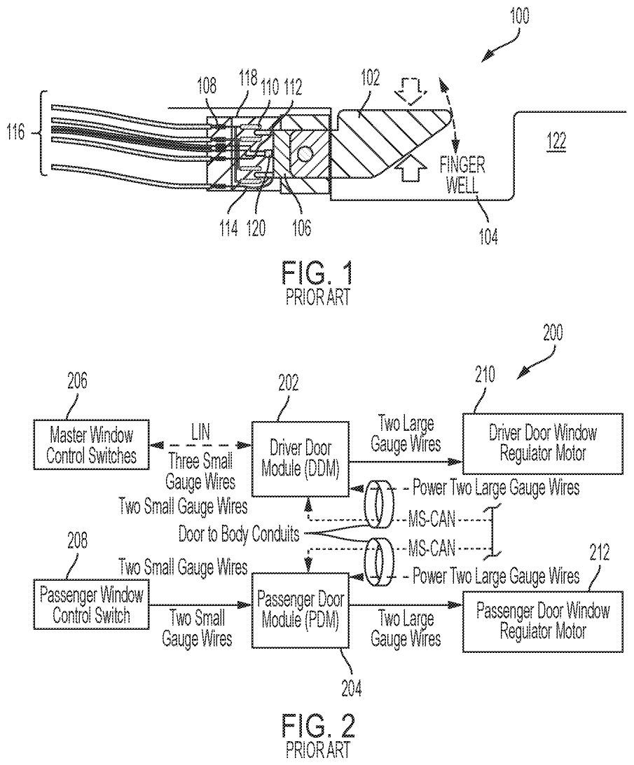

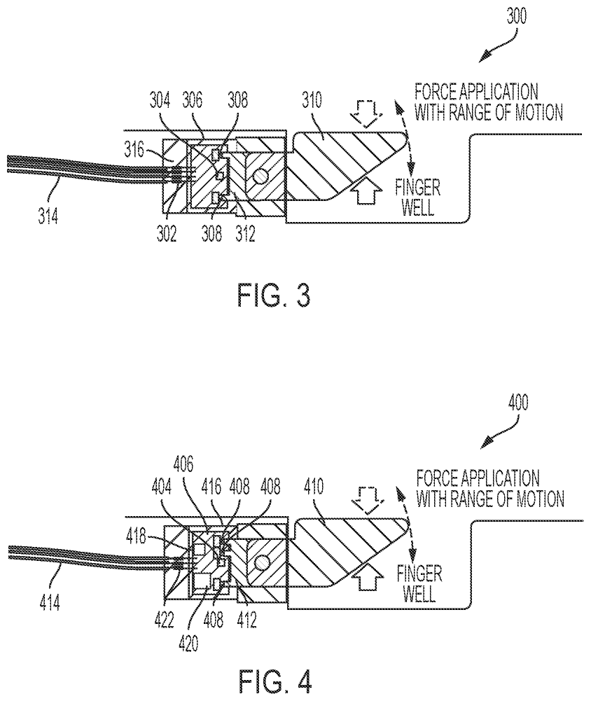

Turning now to FIG. 8, shown therein is a schematic diagram illustrating a safety testing procedure that may be implemented according to applicable NHTSA/DOT power-operated window regulations (e.g., 49 C.F.R. § 571.118) as applied to a traditional/legacy window lift switch apparatus of FIGS. 1-4 and a window lift switch apparatus 500 of FIGS. 5-7. In the conduct of such a safety test, a 20-millimeter diameter tethered stainless steel test sphere 802 is used. The test calls for the test sphere 802 to be moved over the window lift switch apparatus such that 30 lbs. of force is applied by the test sphere 802 to the switch actuator lever 102 (FIG. 1), the switch actuator 310 (FIG. 3), the switch actuator 410 (FIG. 4), or, in the case of the present invention, the force detection projection 503 (FIG. 5). As shown, the geometry of the finger well 506 prevents the test sphere 802 from entering the finger well 506 and striking the force detection projection 503 at a location that would cause the window lift motor to close the window, just as in the case of the traditional/legacy window lift switch apparatus.

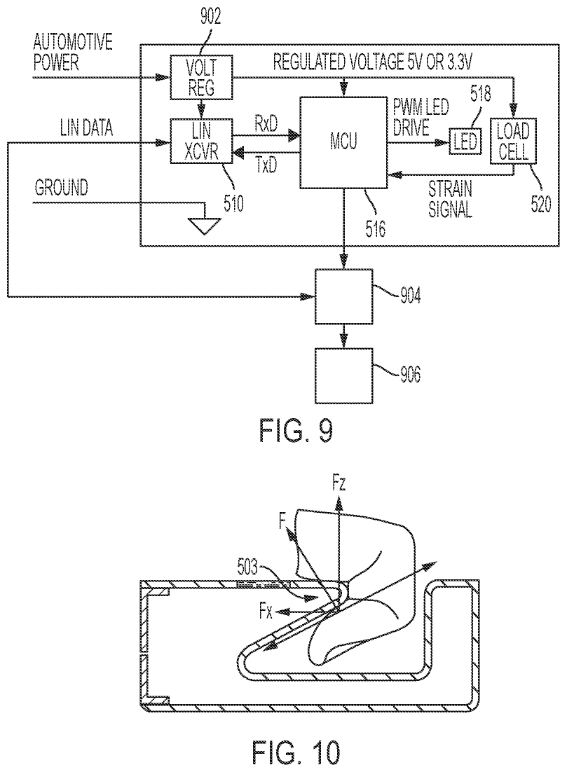

Turning now to FIG. 9, shown therein is a block diagram of the electrical components of the PCB 512 for use with the force detecting window lift switch apparatus 500. In particular, the electrical components include the LIN 510 communications bus, the MCU 516, the light source 518, the load cell 520, and a voltage regulator 902.

As noted above, the LIN 510 communications bus may be used to communicate signals. Since the LIN 510 bus may be limited to low data rate applications, alternate networks could be used. These include a CAN bus, an Ethernet, or other automotive network available in a vehicle.

In one aspect, conversion of the strain signal outputted by the load cell 520 to digital could occur in the load cell 520 or in the MCU 516.

In another aspect, the discrete signals outputted by the MCU 516 are sent to the LIN 510; however, the signals could instead be sent directly to a motor controller 904 associated with one of the window lift motors 906.

The light source 518 LED may be driven using Pulse Width Modulation (PWM) to achieve intensity adjustment. Backlighting could be directed by a LIN 510 message or by a voltage or PWM duty cycle on a discrete signal. If no backlighting is required, a three wire scheme could be used where the resistance to ground on the signaling wire is modulated by the force detected. For example: up=1KΩ, no force=3KΩ, down=10KΩ. For electrical simplicity at the expense of more wires and connector terminals, a force detecting control could have wires dedicated to up, down, and backlighting.

Turning to FIG. 10, shown therein is a schematic diagram of a user's finger curled around the force detection projection 503 of the force detecting window lift switch apparatus 500 according to one possible use of the present invention.

During use of the window lift switch apparatus 500, if an upward applied force, Fz (i.e., a finger pull on or near the apex of the force detection projection 503 in a direction away from the finger well 506) is detected at a level that exceeds a specific threshold force and duration of time (to distinguish it from an unintentional or inadvertent touch), the window lift motor 906 associated with the window lift switch apparatus 500 would be signaled to raise the window.

Likewise, if a downward applied force (i.e., a finger push on the top of the force detection projection 503 in a direction toward the finger well 506) is detected at a level that exceeds a specific threshold and duration, the window lift motor 906 associated with the window lift switch apparatus 500 would be signaled to lower the window.

While particular elements, embodiments, aspects, and applications of the present invention have been shown and described, it will be understood to those skilled in the art to which the invention pertains that the invention is not limited thereto since modifications can be made by those skilled in the art without departing from the spirit and scope of the invention, particularly in light of the foregoing teachings. Accordingly, it is intended that the invention be limited only to the extent required by the appended claims and the applicable rules of law.

We claim:

1. A touch force detecting window lift switch for use in an automobile comprising:
at least one touch force detection component having an elongated top surface, an elongated bottom surface generally opposite the top surface, and an apex formed by a convergence of the top and the bottom surfaces, wherein the shape of the apex is sized to accommodate a user's fingertip curled around a portion of the apex such that it can reach at least a portion of the bottom surface in order to apply a touch force thereon using a pulling motion; and
a printed circuit board positioned between the top and the bottom surfaces of the at least one touch force detection component and having at least one load cell integrated circuit and a microcontroller, wherein an end of the printed circuit board opposite the apex is substantially rigidly fixed and the other end of the printed circuit board closest to the apex is flexibly fixed such that an applied force on the top or the bottom surface of the at least one touch force detection on or near the apex is detectable by the load cell integrated circuit;
wherein the load cell integrated circuit is configured to output an electrical signal indicative of the touch force applied to either the top or the bottom surface, and where the microcontroller is configured to receive and process the electrical signal.

2. The touch force detecting window lift switch according to claim 1, further comprising a housing having a finger well cavity into which the apex of the at least one touch force detection component extends.

3. The touch force detecting window lift switch according to claim 2, wherein the opening to the finger well cavity defined by the apex and the housing has a square or rectangular shape.

4. The touch force detecting window lift switch according to claim 1, further comprising at least one attachment device positioned on an outer surface or edge of the housing for securing the housing in an armrest, a door panel, or a console of the automobile.

5. The touch force detecting window lift switch according to claim 1, further comprising an end cap for enclosing an opening of the housing, wherein the end cap includes one or more openings for passing one or more electrical power and signal leads to the printed circuit board.

6. The touch force detecting window lift switch according to claim 1, wherein the load cell comprises a strain gauge, a resistance bridge, or an amplifier.

7. The touch force detecting window lift switch according to claim 1, wherein the printed circuit board further includes a signal communication component for communicating the electrical signal outputted by the microcontroller to a window lift motor controller.

8. The touch force detecting window lift switch according to claim 7, wherein the communication component is a LIN integrated circuit, a CAN bus, an Ethernet, or other automotive network available in the automobile.

9. The touch force detecting window lift switch according to claim 1, wherein the printed circuit board further includes a light source for backlighting one or more icons or indicia located on the housing.

10. The touch force detecting window lift switch according to claim 1, further comprising software stored in a memory device that when executed is adapted to:
computing a baseline average signal value from a set of individual touch force signal values outputted by the load cell, the set of individual touch force signal values being stored in the memory device or in a separate memory device;
computing a short-term average signal value based on some of the individual touch force signal values in the set of touch force signal values;
comparing the new signal value to the baseline average signal and to the short-term average signal value; and
outputting a window lift motor controller control signal if the magnitude of the new signal value is a fraction of or greater than the computed baseline average signal value or the short-term average signal value.
